(19) United States
(12) Patent Application Publication
(10) Pub. No.: US 2005/0104446 A1
(43) Pub. Date: May 19, 2005

(54) Method of actuating an airplane brake fitted with at least one electromechanical actuator

(75) Inventors: Philippe Chico, Boulogne-Billancourt (FR); Pierre Girod, Paris (FR)

Correspondence Address: SUGHRUE MION, PLLC, 2100 PENNSYLVANIA AVENUE, N.W., SUITE 800, WASHINGTON, DC, 20037, US

(73) Assignee: MESSIER-BUGATTI

(21) Appl. No.: 10/988,621

(22) Filed: Nov. 16, 2004

(30) Foreign Application Priority Data
Nov. 19, 2003 (FR) 03 13530

(51) Int. Cl. B60T 13/66

(52) U.S. Cl. 303/155; 303/191; 303/20; 188/156

(57) ABSTRACT

The invention provides a method of actuating an airplane brake fitted with at least one electromechanical actuator including a pusher that can be displaced in controlled manner in register with a stack of disks to apply a force on the stack of disks in response to a braking reference signal, the method comprising the steps of: when the braking reference signal crosses a contact threshold, controlling the actuator so that the pusher approaches the stack of disks, until the pusher reaches a contact position with the stack of disks; storing said contact position; and then immediately afterwards, controlling the actuator so that the pusher applies a force on the stack of disks in response to the braking reference signal.

The invention relates to a method of actuating an airplane brake fitted with at least one electromechanical actuator.

### BACKGROUND OF THE INVENTION

In braking architectures for airplanes fitted with hydraulic brakes, it is known to control the pistons under force servo-control. To implement such servo-control, the force exerted by the pistons is derived very simply from a measurement of the pressure applied by the airplane hydraulic circuit to the pistons.

In architectures adapted to brakes having electromechanical actuators, each including a pusher which is movable in register with the stack of disks by means of an electric motor for the purpose of exerting a force on the stack of disks in response to a braking reference signal, it is much more difficult to implement force servo-control.

Measuring the force is difficult because it is no longer possible to deduce the force from a measurement of the pressure of a fluid. That makes it necessary to implement specific force sensors, and they are complex to install in the actuator.

In order to remedy those drawbacks, proposals have been made to servo-control the position of the pusher. The position of the pusher can be measured by a specific position sensor, or it can merely be deduced from the number of revolutions needed by the actuator motor in order to move the pusher relative to a reference position of the pusher. Algorithms take account of the mechanical and thermal behavior of the brake to enable the force reference to be transformed into a position reference.

In order to implement servo-control of that type, it is necessary previously to have identified the position of the pusher relative to the stack of disks. For this purpose, it is known, e.g. from document U.S. 2003/0062228 A1, to bring the pusher into contact with the stack of disks, to store the contact position, and then to reverse the pusher away from the contact position as determined in this way, through a distance which corresponds to operating clearance. The brake is thus initialized and ready to operate, with the contact position being stored for all forthcoming braking sequences.

### OBJECT OF THE INVENTION

An object of the invention is to provide a method of actuating an airplane brake fitted with at least one electromechanical actuator, which method provides a response time that is faster than with existing brakes.

### BRIEF DESCRIPTION OF THE INVENTION

More precisely, the invention provides a method of actuating an airplane brake fitted with at least one electromechanical actuator including a pusher that can be displaced in controlled manner in register with a stack of disks to apply a force on the stack of disks in response to a braking reference signal, the method comprising the steps of:
when the braking reference signal crosses a contact threshold, controlling the actuator so that the pusher approaches the stack of disks, until the pusher reaches a contact position with the stack of disks;
storing said contact position; and then
immediately afterwards, controlling the actuator so that the pusher applies a force on the stack of disks in response to the braking reference signal.

Braking is thus initiated immediately after acquiring the contact position, on the fly, without implementing any stage during which the pusher is reversed in order to establish operating clearance between the pusher and the stack of disks. This achieves a precious saving in time which reduces the response time of the brake.

The contact position is thus updated on each braking operation, and therefore takes account of the wear in the stack of disks.

In a particular aspect of the invention, the approach stage is performed with speed servo-control, thus enabling the speed at which the pusher engages the stack of disks to be controlled, thereby reducing the risk of damaging the disks during engagement.

According to another particular aspect of the invention, the step of applying force is implemented by position servo-control using said contact position as its reference.

This contact position is thus updated again on each approach stage.

Preferably, when the braking reference signal drops below a withdrawal threshold, the actuator is controlled so that the pusher moves away from the stack of disks through a predetermined distance measured from said contact position.

This contact position marking the end of the approach stage is thus reused as a reference for the stage of withdrawing the pusher from the stack of disks. Thus, the withdrawal position is updated on each braking operation and therefore takes account of wear in the stack of disks.

Preferably, the withdrawal threshold is lower than the contact threshold.

In this way, the withdrawal stage is not launched when the reference signal passes back through the contact threshold, but a little later, thus making it possible in the event of the reference signal suddenly increasing to apply braking force without waiting for the time needed to perform the withdrawal stage followed by a new approach stage.

Advantageously, when the braking threshold drops below the contact threshold but remains above the withdrawal threshold, the pusher is constrained to remain substantially in the contact position.

In a particular aspect of the invention, when the method of the invention is applied to a brake having actuators that are fitted with pusher locking members, the method includes the step, in the event of the actuator being locked, of unlocking the actuator when the braking reference signal crosses a locking threshold that is lower than the contact threshold.

Advantageously, the locking threshold is lower than the withdrawal threshold.

In another particular aspect of the invention, the contact position is determined by current flowing in the actuator crossing a current threshold, detection of said current crossing the current threshold being activated after the beginning of the pusher being displaced towards the contact position.

### BRIEF DESCRIPTION OF THE DRAWINGS

The invention will be better understood in the light of the following description given with reference to the figures of the accompanying drawing, in which:

FIG. 1 is a diagram of a braking architecture for an airplane fitted with electrochemically actuated brakes; and

FIG. 2 is a set of graphs showing the variations as a function of time in the braking reference signal, in the force exerted by the pusher of the actuator on the stack of disks, and in the position of the pusher.

### DETAILED DESCRIPTION OF THE INVENTION

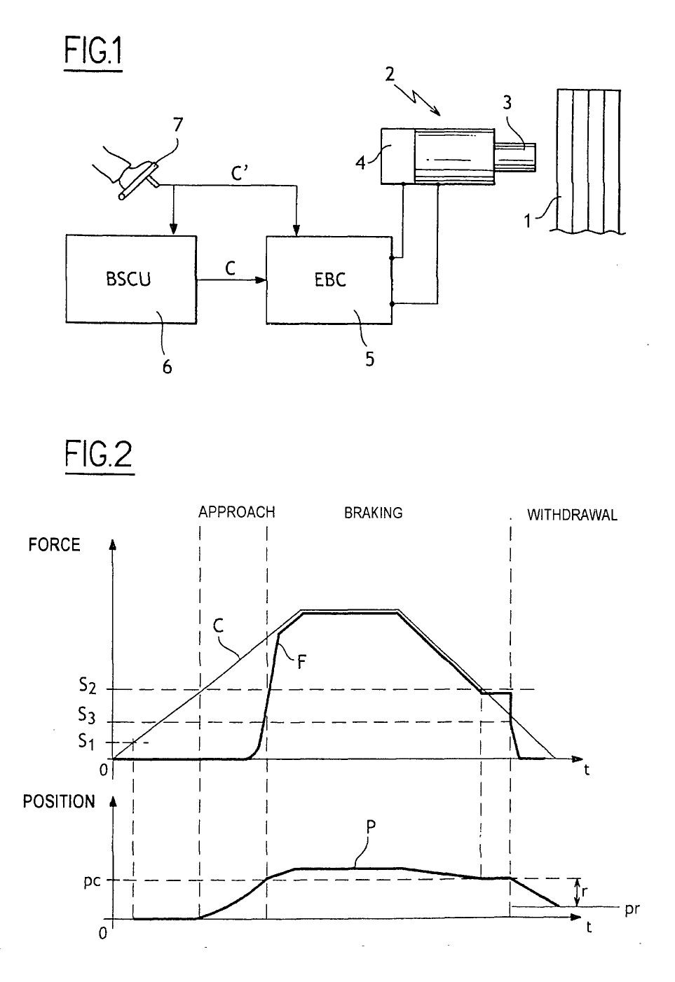

With reference to FIG. 1, electromechanical brakes for an airplane comprise a stack of disks 1 having at least one electromechanical actuator 2 facing the stack. The actuator 2 comprised an electric motor (not shown) which actuates a pusher 3 that is movable in register with the stack of disks 1 in order to apply a braking force thereto.

In this case, the actuator 2 includes a locking member 4 for locking the pusher 3.

The actuator 2 is associated with a control unit 5 (referenced EBC in the figure) which is adapted to control the locking member 4 and to power the electric motor of the actuator 2 as a function of a braking reference signal C generated by a braking calculator 6 (referenced BSCU in the figure).

The braking reference signal C is generated by the braking calculator 6 as a function of signals coming from brake pedals 7 actuated by the pilot of the airplane. In an emergency mode of operation when the braking calculator BSCU 6 has failed, the pedal signal 7 is applied directly to the control unit EBC 5 and acts as an alternative braking reference signal C′.

In FIG. 2, the braking reference signal C is drawn as a fine continuous line on the top graph. The shape of the reference signal has been simplified deliberately. In practice, the reference signal can be subject to sudden variations because of action taken by an anti-skid module which is programmed to lower the braking reference signal as soon as skidding appears on the wheel being braked.

The same graph has a bold line showing variations in the force F applied by the pusher 3 against the stack of disks 1. The bottom graph shows variations in the position P of the pusher 3.

The method of actuation of the invention takes place as follows.

In an initial state, the pusher 3 is at rest and is locked where it is withdrawn relative to the stack of disks 1, corresponding to position 0 in the bottom graph.

In response to the pilot actuating brake pedals, the braking calculator BSCU generates the braking reference signal C which begins by increasing progressively.

The braking control unit EBC 5 is programmed to send an unlocking command to the locking member 4 in response to the braking reference signal C exceeding a threshold S₁, referred to as the locking threshold. The pusher 3 is then released and can be moved immediately by powering the electric motor of the actuator 2.

As the braking reference signal continues to increase, it crosses a threshold S₂ referred to as the contact threshold. In response to crossing this threshold, the control unit EBC 5 is programmed to move the pusher 3 towards the stack of disks 1, with the speed of the pusher being servo-controlled to a predetermined reference speed.

It can be seen in the bottom graph that the approach stage of the pusher 3 begins as soon as the braking reference signal C crosses the contact threshold S₂, and ends when the pusher 3 reaches a contact position pc against the stack of disks 1.

The definition of the contact position pc is arbitrary. In this case, the position used as the contact position pc is the position in which the current carried by the electric motor of the actuator 2 crosses a current threshold.

The increase in current flowing through the electric motor is due to the fact that the pusher 3 is subjected to an opposing force, specifically the reaction force exerted by the stack of disks 1. In this respect, it should be observed that the electric motor is constrained, at the beginning of pusher displacement, to generate a large force in order to accelerate the moving parts of the actuator that were initially at rest. This torque requires electric current that can exceed the current threshold.

To avoid detecting a position that does not correspond to the desired contact position, detection of the current threshold being crossed is not activated until after the pusher has started to move, leaving time for the initial current peak to die down (in practice, this offset is of the order of a few hundredths of a second). This ensures that when the current threshold is crossed by the current, that crossing is indeed due to the pusher 3 coming into contact against the stack of disks 1, and not to the inertia of the moving parts.

The pusher 3 is thus brought into contact with the stack of disks 1 at a controlled speed, avoiding any sudden impact which might damage the disks.

The approach stage terminates when contact is detected.

Thereafter, the method enters into a braking stage proper during which the pusher 3 is servo-controlled in such a manner that the force F it exerts on the stack of disks 1 tracks the braking reference signal C. The servo-control performed in this example is position servo-control using the contact position pc as the reference.

If the braking reference signal drops below the contact threshold S₂, but remains above a third threshold S₃ referred to as the withdrawal threshold, the pusher is constrained to remain in the contact position pc.

It is only when the braking reference signal C drops below the withdrawal threshold S₃ that a withdrawal stage begins during which the pusher 3 is displaced towards a withdrawal position pr that is set back from the contact position pc by a predetermined withdrawal distance r.

The reference position used for withdrawal is thus the contact position pc as detected and stored during the approach stage. The contact position pc is thus updated on each braking operation, thereby taking account of wear in the stack of disks.

The withdrawal position pr thus varies as the stack of disks becomes worn, so as to ensure that the withdrawal distance r is constant. It can be seen from the bottom graph, that because of wear in the stack of disks, the withdrawal position pr no longer corresponds to the initial position occupied by the pusher 3 before the approach stage was engaged.

Maintaining a constant withdrawal distance r makes it possible to guarantee that for a given reference speed, the approach stage is always of substantially the same duration. This constant duration makes it possible to ensure reproducibility in the response time of the actuator to a braking command.

The withdrawal threshold S₃ of the invention is selected to be lower than the contact threshold S₂. It can happen during braking that the reference signal drops below the contact threshold S₂, for example during actuation of the anti-skid module in response to detecting skidding of the braked wheel.

If the withdrawal stage were to be triggered on crossing the contact threshold S₂, it would then be necessary on restarting braking to wait for the end of the withdrawal stage, and then to engage a new approach stage, and that would take a long time.

To avoid that drawback, the withdrawal stage is triggered only at a withdrawal threshold S₃ that is lower than the contact threshold S₂. This provides a range in which the braking reference signal can drop below the contact threshold S₂ but without that triggering the withdrawal stage, thus enabling the actuator to respond immediately to a reference signal increasing suddenly.

Advantageously, the withdrawal threshold S₃ is selected to be higher than the locking threshold S₁. This reserves a range between the moment at which the withdrawal stage is engaged and the moment at which the actuator is locked, thus making it possible, in the event of the braking reference signal suddenly increasing, to trigger the approach stage immediately without having to wait for the end of the locking sequence following by an unlocking sequence. This disposition thus also enables the actuator to respond more quickly.

When the reference signal finally crosses the locking threshold S₁, the pusher 3 is locked again.

The invention is not limited to the particular implementations of the invention as described above, but on the contrary covers any variant coming within the ambit of the invention as defined by the claims.

In particular, although it is stated that force is applied during the braking stage under position servo-control, it is also possible to apply this force using some other type of servo-control, for example force servo-control. Under such circumstances, when the braking reference signal lies between the contact threshold and the withdrawal threshold, the pusher is constrained to exert a force which corresponds to a reference value that is equal to the contact threshold.

1. A method of actuating an airplane brake fitted with at least one electromechanical actuator including a pusher that can be displaced in controlled manner in register with a stack of disks to apply a force on the stack of disks in response to a braking reference signal, the method comprising the steps of:
when the braking reference signal crosses a contact threshold, controlling the actuator so that the pusher approaches the stack of disks, until the pusher reaches a contact position with the stack of disks;
storing said contact position; and then
immediately afterwards, controlling the actuator so that the pusher applies a force on the stack of disks in response to the braking reference signal.

2. A method according to claim 1, wherein the approach stage is performed with under-speed servo-control.

3. A method according to claim 1, wherein the step of applying force is implemented by position servo-control using said contact position as its reference.

4. A method according to claim 1, wherein, when the braking reference signal drops below a withdrawal threshold, the actuator is controlled so that the pusher moves away from the stack of disks through a predetermined distance measured from said contact position.

5. A method according to claim 4, wherein the withdrawal threshold is lower than the contact threshold.

6. A method according to claim 5, wherein, when the braking threshold drops below the contact threshold but remains above the withdrawal threshold, the pusher is constrained to remain substantially in the contact position.

7. A method according to claim 1, applied to a brake whose actuator is fitted with a pusher locking member, the method including the step, in the event of the actuator being locked, of unlocking the actuator when the braking reference signal crosses a locking threshold that is lower than the contact threshold.

8. A method according to claim 7, wherein the locking threshold is lower than the withdrawal threshold.

9. A method according to claim 1, wherein the contact position is determined by current flowing in the actuator crossing a current threshold, detection of said current crossing the current threshold being activated after the beginning of the pusher being displaced towards the contact position.
